(19) United States
(12) Patent Application Publication
(10) Pub. No.: US 2012/0270038 A1
(43) Pub. Date: Oct. 25, 2012

(54) PRESSURE-SENSITIVE ADHESIVE COMPOSITION FOR OPTICAL USE

(75) Inventors: Sung Min Kim, Seoul (KR); In Kyu Song, Gyeonggi-Do (KR); Young Sik Choi, Gyeonggi-Do (KR)

(73) Assignee: DONGWOO FINE-CHEM CO., LTD., Jeollabuk-do (KR)

(21) Appl. No.: 13/426,315

(22) Filed: Mar. 21, 2012

(30) Foreign Application Priority Data
Apr. 21, 2011 (KR) 10-2011-0037367

(51) Int. Cl. B32B 3/00; B32B 15/04; C09J 175/16

(52) U.S. Cl. 428/336; 522/96; 525/454; 428/355 N

(57) ABSTRACT

A pressure-sensitive adhesive composition for optical use is disclosed. The adhesive composition includes 40 to 80 wt. % of a mono-functional urethane acrylate oligomer; 5 to 55 wt. % of isobornyl (meth)acrylate as a first mono-functional diluted monomer; 5 to 55 wt. % of a second mono-functional diluted monomer having a glass transition temperature of not less than 1° C. and an unsaturated ethylene group; and 0.1 to 5 wt. % of a free radical photo-initiator, so as to attain excellent adhesiveness to inorganic materials as well as plastic materials, durability such as heat resistance and moist heat resistance, and shear strain, wherein it does not contain any alternative solvent, to thereby render a thick film type adhesive film to be fabricated.

### RELATED APPLICATIONS

This application claims priority from Korean Patent Application No. 10-2011-0037367, filed on Apr. 21, 2011 in the Korean Intellectual Property Office, the entire disclosure of which is incorporated herein by reference.

### FIELD OF THE INVENTION

The present invention relates to a pressure-sensitive adhesive composition for optical use, having favorable adhesiveness to inorganic materials as well as plastic materials, specifically adhesives for touch screen displays.

### BACKGROUND OF THE INVENTION

In recent years, with the rapidly advancing display industries, mounting of a touch panel or touch screen or using an optically transparent pressure-sensitive adhesive to embody high brightness and high permeability, have frequently been proposed and used.

The touch panel or touch screen refers to a device for detecting a location coordinate by recognizing a variation in potential difference occurring by means of a constant input tool such as a pen or a finger. More particularly, by pressing any one point of an upper substrate, an upper electrode formed of a transparent conductive film on the lower side of an upper substrate comes into contact with a lower electrode formed of a transparent conductive film on a lower substrate, so as to generate a potential difference and then recognize a variation in the potential difference.

In recent years, the touch panel or touch screen is currently used as a device combined with a display device and configured to input information therein.

A pressure-sensitive adhesive used for bonding a transparent conductive film to such a touch screen or touch panel needs favorable adhesiveness to a variety of substrates and, at the same time, durability sufficient to inhibit curling or bubbling even where it is exposed to strict conditions such as high temperature, high humidity, or the like.

In general, in order to guarantee sight recognition of a display, an acryl or urethane acrylic pressure-sensitive adhesive is used. Such a pressure-sensitive adhesive further requires film thickening (thickness: 50 to 1000 m) and entails known problems including deterioration in physical properties required for an adhesive layer, i.e., adhesion under bitter conditions, and durability such as heat resistance.

### SUMMARY OF THE INVENTION

Therefore, in one embodiment of the present invention, a pressure-sensitive adhesive composition for optical use is provided, with adhesiveness to inorganic materials as well as plastic materials, excellent durability such as heat resistance and moist heat resistance, and superior shear strain, wherein the composition is prepared using a urethane acrylate oligomer.

In fact, it was found that a mono-functional urethane acrylate oligomer may gain favorable adhesiveness to plastic materials such as a polyethylene terephthalate (PET) film and a triacetyl cellulose (TAC) film, as well as inorganic materials such as glass, and excellent durability and shear strain, by adding specified mono-functional diluted monomers such as isobornyl (meth)acrylate and a compound having a constant range of glass transition temperature (Tg) and a particular structure, in predetermined amounts thereof, to the oligomer.

In order to accomplish the above object, in an embodiment of the present invention, an adhesive composition for optical use may be prepared that comprises: 40 to 80 wt. % of a mono-functional urethane acrylate oligomer; 5 to 55 wt. % of isobornyl (meth)acrylate as a first mono-functional diluted monomer; 5 to 55 wt. % of a second mono-functional diluted monomer having a glass transition temperature (Tg) of not less than 1□ and an unsaturated ethylene group; and 0.1 to 5 wt. % of a free radical photo-initiator.

The mono-functional urethane acrylate oligomer may have an ester main chain, an ether main chain, or a main chain having a combined structure of both the aforesaid main chains.

The second mono-functional diluted monomer may have a glass transition temperature (Tg) ranging from 1 to 150□.

In addition, in another embodiment of the present invention, a pressure-sensitive adhesive for optical use may be formed by curing the above adhesive composition.

Further, in yet another embodiment of the present invention, an adhesive film may be prepared comprising: a transparent substrate film; and the above adhesive formed on one face of the transparent substrate film.

The adhesive may have a thickness of 25 to 1000 μm.

### DETAILED DESCRIPTION OF THE INVENTION

According to some embodiments of the present invention, there is provided a pressure-sensitive adhesive composition for optical use, having favorable adhesiveness to inorganic materials as well as plastic materials, excellent durability such as heat resistance, moist heat resistance, etc., and superior shear strain.

Hereinafter, the foregoing features of embodiments of the present invention will be more readily understood by reference to the following detailed description and examples.

A pressure-sensitive adhesive composition for optical use according to an embodiments of the present invention may comprise a mono-functional urethane acrylate oligomer, a first mono-functional diluted monomer based on isobornyl (meth)acrylate, a second mono-functional diluted monomer having a glass transition temperature (Tg) of not less than 1° C. and an unsaturated ethylene group, and a free radical photo-initiator.

The mono-functional urethane acrylate oligomer may have a primary function to endow physical properties and flexibility to an adhesive, thus retaining visco-elasticity and storage elasticity. Here, if the above urethane acrylate oligomer is multi-functional, surface polishing properties are decreased while cohesive strength is too large, in turn causing a difficulty in expressing adhesive characteristics.

The mono-functional urethane acrylate oligomer is generally prepared by combining a main chain part based on a polyol molecular structure, a urethane bond formed by reaction between isocyanate and polyol, and an acrylate monomer having a hydroxyl group, to thereby generate a reactive group of acryloyl group at an end.

The main chain described above may be derived from polyol having at least one molecular structure selected from a group consisting of polyether, polyester, polyolefin, polyacrylate and polycarbonate. In aspects of cost and easy viscosity control, the main chain is preferably derived from polyester, polyether and/or polyol having a combined structure of these two materials.

The oligomer may refer to a low molecular weight polymer compound having a weight mean molecular weight (Mw) ranging from 1,000 to 40,000, and preferably, 1,000 to 35,000.

The mono-functional urethane acrylate oligomer may be prepared by polymerization of polyol and a diisocyanate compound known in the art. Polyol may be prepared using, for example, ethylene oxide, propylene oxide, or a cyclic ether monomer, i.e., oxirane such as tetrahydrofuran. Also, using a cyclic ester such as ε-caprolactone or pivalolactone may produce an oligomer having an ester main chain.

By reacting the prepared polyol with a diisocyanate compound, a polyol structure having a urethane bond may be obtained. The diisocyanate compound preferably includes an aliphatic diisocyanate compound selected from a group consisting of 1,4-butylene diisocyanate, 1,6-hexamethylene diisocyanate, cyclopentylene-1,3-diisocyanate, 4,4′-dicyclohexylmethane diisocyanate, isophorone diisocyanate, cyclohexene-1,4-diisocyanate, 2,4-tollylene diisocyanate, 2,6-tollylene diisocyanate, 4,4′-methylene bis(phenyl isocyanate), 2,2-diphenylpropane-4,4′-diisocyanate, p-phenylene diisocyanate, m-phenylene diisocyanate, xylene diisocyanate, 1,4-naphthalene diisocyanate, 1,5-naphthylene diisocyanate, 4,4′-diphenyl diisocyanate, azobenzene-4,4′-diisocyanate, m- or p-tetramethylxylene diisocyanate, and 1-chlorobenzene-2,4-diisocyanate.

The polyol and the diisocyanate described above generally react with each other in an equivalence ratio thereof, and an excess amount of diisocyanate may be included to improve reaction efficiency.

Also, in order to couple an acryloyl group to the reactant, 2-hydroxyethyl (meth)acrylate having a hydroxyl group may be used in the reaction, thus preparing a urethane acrylate oligomer. During reaction, when adding a proper amount of alcohol (typically, buthanol), the acryloyl group is formed from 2-hydroxyethyl (meth)acrylate at one side, while a mono-functional urethane acrylate oligomer terminated with alcohol may be produced at the other side.

The mono-functional urethane acrylate oligomer may have a glass transition temperature (Tg) ranging from −60 to 50° C., preferably −60 to 20° C.

The mono-functional urethane acrylate oligomer may be contained in the range of 40 to 80 wt. %, and preferably, 50 to 70 wt. %. If the content is less than 40 wt. %, the adhesive composition may have a low viscosity, thus causing a problem in coating. On the other hand, when the content exceeds 80 wt. %, it may be difficult to control the balance between the viscosity of the adhesive composition and optical properties.

The first mono-functional diluted monomer, i.e., isobornyl (meth)acrylate has an isobornyl group as a stereoscopic shape alicyclic group and a glass transition temperature (Tg) of about 96° C. thus improving adhesiveness when it is used for an adhesive comprising a urethane acrylate oligomer as a major ingredient. Specifically, adhesiveness to an inorganic material such as glass may be enhanced. Compared to an acrylate monomer having a relatively low glass transition temperature (Tg), a curing rate is increased in curing the foregoing material with the same oligomer, thus being preferable.

The second mono-functional diluted monomer may control a viscosity of the adhesive composition to be easily applied, and may be used in combination with the first mono-functional diluted monomer to enhance cohesive strength and/or adhesive strength of plastic materials such as a polyethylene terephthalate (PET) film, a triacetyl cellulose (TAC) film, or the like.

The second mono-functional diluted monomer may be one having a glass transition temperature (Tg) of not less than 1° C. If the glass transition temperature is less than 1° C., adhesive strength is decreased and adhesiveness to the glass, polyethylene terephthalate (PET) film and/or triacetyl cellulose (TAC) film is reduced. Therefore, in consideration of adhesion to a face to be adhered, the glass transition temperature (Tg) may range from 1 to 150° C.

Meanwhile, the diluted monomer may comprise a mono-functional acryl-based monomer having an ethylene unsaturated group. More particularly, at least one selected from a group consisting of ethyl acrylate, methyl (meth)acrylate, 2-ethylhexyl (meth)acrylate, butyl acrylate, isobutyl acrylate, allyl methacrylate, 2-ethoxyethyl (meth)acrylate, isodecyl (meth) acrylate, 2-dodecylthioethyl methacrylate, octyl acrylate, isooctyl acrylate, 2-methoxyethyl acrylate, hydroxyethyl (meth) acrylate, hydroxypropyl (meth) acrylate, hydroxylbutyl (meth) acrylate, isooctyl (meth) acrylate, isodexyl (meth)acrylate, stearyl (meth)acrylate, tetrafurfuryl (meth) acrylate, phenoxyethyl (meth) acrylate, octadecyl methacrylate, tetrahydrofuryl acrylate and acryloyl morpholine may be used.

Considering the glass transition temperature (Tg), at least one selected from a group consisting of acryloyl morpholine, acrylic acid, t-butyl acrylate, tetrahydrofurfuryl methacrylate, lauryl(C12) acrylate and cyclohexyl acrylate, is preferably used.

Such a second mono-functional diluted monomer may be contained in an amount of 5 to 55 wt. %, and preferably, 5 to 40 wt. %. If the content is less than 5 wt. %, an increase in adhesive strength thereof to a plastic material is expected to be very little. On the other hand, if the content is more than 55 wt. %, curing shrinkage is severe or the prepared adhesive may be hardened.

Further, the present invention may additionally include a di-functional or more diluted monomer, without departing from the purposes of the present invention and functional effects thereof. The di-functional or more diluted monomer may function to control a curing rate and, in consideration of purposes and functions of the present invention and a predetermined range of the curing rate to be controlled, the amount of the diluted monomer is preferably used in a suitable amount thereof.

More particularly, the di-functional or more diluted monomer may include, for example: di-functional monomers such as 1,3-butanediol di(meth)acrylate, 1,4-butanediol di(meth)acrylate, 1,6-hexanediol di(meth)acrylate, ethyleneglycol di(meth)acrylate, bisphenol A-ethyleneglycol diacrylate, diethyleneglycol di(meth)acrylate, triethyleneglycol di(meth)acrylate, polyethyleneglycol (meth) acrylate, propyleneglycol di(meth)acrylate, dipropyleneglycol di(meth)acrylate, tripropyleneglycol di(meth)acrylate, neopentylglycol di(meth)acrylate, dicyclopentanyl di(meth)acrylate, caprolactone-modified dicyclopentenyl di(meth)acrylate, ethylene oxide-modified phosphate di(meth)acrylate, bis(2-hydroxyethyl)isocyanurate di(meth)acrylate, di(acryloxyethyl)isocyanurate, allylated cyclohexyl di(meth)acrylate, dimethylol dicyclopentane diacrylate, ethylene oxide-modified hexahydrophthalate diacrylate, tricyclodecane dimethanol acrylate, neopentylglycol-modified trimethylol propane diacrylate, adamantine diacrylate, or the like; tri-functional monomers such as trimethylolpropane tri(meth)acrylate, pentaerythritol tri(meth)acrylate, dipentaerythritol tri(meth)acrylate, propionic acid-modified dipentaerythritol tri(meth)acrylate, propylene oxide-modified trimethylol propane tri(meth)acrylate, tris(2-hydroxyethyl)isocyanurate tri(meth)acrylate, tris(acryloxyethyl)isocyanurate, glycerol tri(meth)acrylate, or the like; tetra-functional monomers such as diglycerin tetra(meth)acrylate, pentaerythritol tetra(meth)acrylate, ditrimethylolpropane tetra(meth)acrylate, or the like; penta-functional monomers such as propionic acid-modified dipentaerythritol penta(meth)acrylate or the like; and/or hexa-functional monomers such as dipentaerythritol hexa(meth)acrylate, caprolactone-modified dipentaerythritol hexa(meth)acrylate, or the like.

The di-functional or more diluted monomer may be contained in an amount of 5 wt. % relative to total 100 wt. % of the composition.

A free-radical photo-initiator serves to sufficiently proceed internal and/or surface curing of the adhesive, and may include any one known in the art without particular limitation thereof.

Particular examples of the free radical photo-initiator may include; benzoin, benzoin methylether, benzoin ethylether, benzoin isopropylether, benzoin-n-butylether, benzoin isobutylether, acetophenone, hydroxydimethyl acetophenone, dimethylamino acetophenone, dimethoxy-2-phenyl acetophenone, 3-methyl acetophenone, 2,2-dimethoxy-2-phenyl acetophenone, 2,2-diethoxy-2-phenyl acetophenone, 4-chloroacetophenone, 4,4-dimethoxy acetophenone, 2-hydroxy-2-methyl-1-phenylpropan-1-on, 4-hydroxy cyclophenylketone, 1-hydroxy cyclohexylphenylketone, 2-methyl-1-[4-(methylthio)phenyl]-2-morpholino-propan-1-on, 4-(2-hydroxyethoxy)phenyl-2-(hydroxyl-2-propyl)ketone, benzophenone, p-phenylbenzophenone, 4,4-diaminobenzophenone, 4,4′-diethylaminobenzophenone, dichlorobenzophenone, anthraquinone, 2-methylanthraquinone, 2-ethylanthraquinone, 2-t-butylanthraquinone, 2-aminoanthraquinone, 2-methylthioxanthone, 2-ethylthioxanthone, 2-chlorothioxantone, 2,4-dimethylthioxanthone, 2,4-diethylthioxanthone, benzyldimethylketal, diphenylketone benzyldimethylketal, acetophenone dimethylketal, p-dimethylamino benzoic ester, 2,4,6-trimethylbenzoyl-diphenyl-phosphine oxide, fluorene, triphenylamine, carbazole, or the like. In addition, among commercially available products in the market, Darocur 1173, Irgacure 184, Irgacure 907, etc. (trade name; manufactured by Ciba Co.) may also be used. These materials may be used alone or in combination of two or more thereof.

The free radical photo-initiator described above may be used in a proper amount in consideration of radiation features of a light source, strength, contents of individual ingredients, etc., for example, in 0.1 to 5 wt. % relative to a total weight of the adhesive composition (100 wt. %).

The adhesive composition may be hardened to form an adhesive. Furthermore, an adhesive film may comprise a transparent substrate film, and the aforesaid adhesive provided on one face of the transparent substrate film.

The adhesive may have a thickness ranging from 25 to 1000 μm.

The transparent substrate film may be any one having favorable transparency, mechanical strength, thermal stability and/or moisture shielding properties, without being particularly limited thereto.

The curing process may be any method used in the art, without being particularly limited thereto. In general, UV based photo-curing may be used.

UV polymerization is performed with a light source having a light emitting distribution of wavelengths of not more than 400 nm, preferably 150 to 400 nm, and more preferably, 200 to 380 nm. For instance, a low pressure mercury arc lamp, a medium pressure mercury arc lamp, a high pressure mercury arc lamp, an ultra-high pressure mercury arc lamp, a chemical lamp, a black-light lamp, a microwave excited mercury arc lamp, a metal halide lamp, and so forth, may be used.

The intensity of the light irradiation may be suitably controlled according to desired physical properties of an adhesive, and an integrated quantity of light useful for activating the free radical photo-initiator may range from 10 to 5000 mJ/cm², and preferably, 200 to 2000 mJ/cm². Within the aforesaid range, a curing reaction time may be suitable and a hardened material formed by radiant heat of the lamp and heat emitted in polymerization does not either encounter a decrease in cohesion or cause yellowing or deterioration in a support material, thereby being preferable.

Preferred embodiments will be described with reference to examples and comparative examples below. However, it will be apparent to those skilled in the art that such embodiments are provided for illustrative purposes and do not limit subject matters to be protected as defined by the appended claims.

### EXAMPLES

### Example 1

(1) Adhesive Composition

60 wt. % of a mono-functional urethane acrylate oligomer (trade name: DFCN-5, manufactured by Negami Chemical Industrial Co. Ltd.), 28 wt. % of a first mono-functional diluted monomer, i.e., isobornylacrylate (Tg=94° C.), 10 wt. % of a second mono-functional diluted monomer, i.e., t-butyl acrylate (Tg=41° C.), and 2 wt. % of a free radical photo-initiator (trade name: Darocur-1173, manufactured by Ciba Co.), were mixed together, to prepare an adhesive composition.

(2) Formation of Adhesive Film

The adhesive composition prepared in the above (1) was applied to a transparent substrate film coated with a silicon release agent to have a thickness of 300 m, followed by UV irradiation at a rate of 4 m/min (600 mJ/cm²). Then, after stacking the same transparent substrate film thereon, UV irradiation was again conducted at a rate of 4 m/min (600 mJ/cm²), to thereby complete curing and finally form an adhesive.

### Examples 2 to 9 and Comparative Examples 1 to 6

The same procedures described in Example 1 were repeated except that constitutional compositions of individual ingredients listed in the following TABLE 1 were employed.

TABLE 1

| | Mono- | | | | | | | | | | | |
|---|---|---|---|---|---|---|---|---|---|---|---|---|
| | functional | | | | | | | | | | | |
| | urethane | | | | | | | | | | | Free |
| | acrylate | | Diluted monomer | | | | | | | | | radical |
| Section | oligomer | | Mono-functional | | | | | | | | Di- | photo- |
| (wt. %) | A-1 | A-2 | B-1 | B-2 | B-3 | B-4 | B-5 | B-6 | B-7 | B-8 | functional | initiator |
| Ex. 1 | 60 | — | 28 | 10 | — | — | — | — | — | — | — | 2 |
| Ex. 2 | 60 | — | 28 | — | 10 | — | — | — | — | — | — | 2 |
| Ex. 3 | 60 | — | 33 | — | — | 5 | — | — | — | — | — | 2 |
| Ex. 4 | 60 | — | 27 | — | — | — | 10 | — | — | — | 1 | 2 |
| Ex. 5 | 60 | — | 27 | — | — | — | — | 10 | — | — | 1 | 2 |
| Ex. 6 | — | 60 | 28 | 10 | — | — | — | — | — | — | — | 2 |
| Ex. 7 | 50 | — | 23 | 20 | — | — | 5 | — | — | — | — | 2 |
| Ex. 8 | 70 | — | 20 | — | — | — | 6 | — | — | — | 2 | 2 |
| Ex. 9 | — | 45 | 20 | 20 | — | — | 12 | — | — | — | 1 | 2 |
| Com. | 85 | — | 8 | — | — | — | 5 | — | — | — | — | 2 |
| Ex. 1 | | | | | | | | | | | | |
| Com. | 35 | — | 58 | — | — | — | 5 | — | — | — | — | 2 |
| Ex. 2 | | | | | | | | | | | | |
| Com. | 60 | — | — | — | — | — | — | — | 38 | — | — | 2 |
| Ex. 3 | | | | | | | | | | | | |
| Com. | 58 | — | 20 | — | — | — | — | — | 20 | — | — | 2 |
| Ex. 4 | | | | | | | | | | | | |
| Com. | 56 | — | 20 | — | — | — | — | — | 20 | — | 2 | 2 |
| Ex. 5 | | | | | | | | | | | | |
| Com. | 60 | — | 20 | — | — | — | — | — | — | 16 | 2 | 2 |
| Ex. 6 | | | | | | | | | | | | |
| Com. | 68 | — | 30 | — | — | — | — | — | — | — | — | 2 |
| Ex. 7 | | | | | | | | | | | | |
| Com. | — | 68 | 30 | — | — | — | — | — | — | — | — | 2 |
| Ex. 8 | | | | | | | | | | | | |

A-1: Trade name DFCN-5, Negami Chemical Industrial Co. Ltd., weight mean molecular weight (Mw) = 31000, mono-functional, ether main chain
A-2: Trade name DFCN-12, Negami Chemical Industrial Co. Ltd., weight mean molecular weight (Mw) = 22000, mono-functional, ester main chain
B-1: Isobornyl acrylate, Tg = 94° C.
B-2: t-Butyl acrylate, Tg = 41° C.
B-3: Acryloylmorpholine, Tg = 145° C.
B-4: Acrylic acid, Tg = 106° C.
B-5: 2-Hydroxyethyl methacrylate, Tg = 55° C.
B-6: Tetrahydrofurfuryl methacrylate, Tg = 60° C.
B-7: 2-ethylhexyl acrylate, Tg = 60° C.
B-8: Butyl acrylate, Tg = 54° C.
Di-functional diluted monomer: 1,6-Hexanediol diacrylate, Tg = 43° C.
Free radical photo-initiator: Darocur-1173, Ciba Co.

### Testing Example

Each of the adhesive compositions and adhesive films prepared in the foregoing Examples and Comparative Examples was subjected to measurement of physical properties according to the following procedures, results thereof are shown in TABLE 2.

1. Adhesiveness (N/25 mm)

(1) Glass Adhesion

After delaminating the substrate film coated with a releasing agent applied thereto from the adhesive film, as prepared above, a PET substrate film without a releasing process was laminated. The adhesive sheet was cut into a dimension of 25 mm×250 mm using a super cutter, attached to a glass, fixed to an autograph, and treated by 180° peel releasing at a rate of 300 m/min, which in turn was subjected to determination of glass adhesion.

(2) Triacetyl Cellulose (TAC) Film Adhesion

Using a double-sided adhesive tape, a TAC film was attached to a glass to prepare a TAC film-adhered glass. After delaminating the substrate film coated with a releasing agent applied thereto from the adhesive film, as prepared above, the treated adhesive film was laminated on a TAC film. The adhesive sheet, as prepared above, was cut into a dimension of 25 mm×250 mm using a super cutter, attached to the above prepared TAC film-adhered glass, fixed to an autograph, and treated by 180° peel releasing at a rate of 300 m/min, which in turn was subjected to determination of TAC film adhesion.

(3) Polyethylene Terephthalate (PET) Film Adhesion

Using a double-sided adhesive tape, a PET film was attached to a glass to prepare a PET film-adhered glass. After delaminating the substrate film coated with a releasing agent applied thereto from the adhesive film, as prepared above, the treated adhesive film was laminated on a PET film. The adhesive sheet, as prepared above, was cut into a dimension of 25 mm×250 mm using a super cutter, attached to the above prepared PET film-adhered glass, fixed to an autograph, and treated by 180° peel releasing at a rate of 300 m/min, which in turn was subjected to determination of PET film adhesion.

2. Heat Resistance

After delaminating the substrate film coated with a releasing agent from the adhesive film, a treated film was laminated above a PET film without a releasing process. The adhesive sheet was cut into an A4 size using a super cutter, adhered to a glass, treated in an autoclave at 50° C. and 5 atms for 20 minutes, and then, left to rest in a heat resistant oven at 80° C. for 100 hours.

⊚—After assessing heat resistance, failures such as bubbling are not detected.

◯—After assessing heat resistance, less than 10 air bubbles having a size of less than 1 μm are generated along a peripheral side of the sheet.

Δ—After assessing heat resistance, 10 or more of air bubbles having a size of less than 1 μm are generated along a peripheral side of the sheet.

X—After assessing heat resistance, severe bubbling and/or delamination are resulted.

3. Moist Heat Resistance

After delaminating the substrate film coated with a releasing agent from the adhesive film, a treated film was laminated above a PET film without a releasing process. The adhesive sheet was cut into an A4 size using a super cutter, adhered to a glass, treated in an autoclave at 50° C. and 5 atms for 20 minutes, and then, left to rest in a moist heat resistant oven at 60° C. and 60 RH % for 100 hours.

⊚—After assessing moist heat resistance, failures such as bubbling are not detected.

◯—After assessing moist heat resistance, less than 10 air bubbles having a size of less than 1 μm are generated along a peripheral side of the sheet.

Δ—After assessing moist heat resistance, 10 or more of air bubbles having a size of less than 1 μm are generated along a peripheral side of the sheet.

X—After assessing heat resistance, severe bubbling and/or delamination are resulted.

4. Shear Strain (%)

After delaminating the substrate film coated with a releasing agent from the adhesive film, a treated film was laminated above a PET film without a releasing process. The adhesive sheet was cut into a size of 2.54 cm×10 cm using a super cutter, adhered to a glass to reach an adhesion area of 2.54 cm×1.27 cm, thereby preparing a sample for shear strain.

The shear strain was measured using a tensile tester (equipped with a temperature-controllable oven) and conditions thereof are as follows. The shear strain after 3600 sec was calculated according to Equation 1 below.

Static load: 9.8 N

Temperature: 50 ° C.

Measuring time: 3600 sec

$$\begin{matrix} [ Equation 1 ] & \\ Shear strain ( \% ) = \frac{Extended length ( § - )}{Initial thickness of adhesive ( § - )} ¡¿100 & \end{matrix}$$

In this regard, if the shear strain is less than 400%, it is deemed that high temperature creep properties are favorable. On the other hand, if the shear strain is ‘∞’, it demonstrates that shear strain is rapidly increased to cause cohesive failure before 3600 sec.

5. Curing Rate

Consumption extent of unsaturated C—C double bonds among unsaturated groups contained in both of mono-functional urethane acrylate oligomer component and mono-functional diluted monomer component during curing, as a function of time, was determined by a Fourier Transform Infrared Spectrometry (FT-IR) technique.

Assessment Device: FT-IR

Measurement method: Measuring disappearance level of unsaturated C—C double bonding signal at 810 cm⁻¹.

Percentage of consumption means percentage of double bonds disappeared during UV irradiation with 0% before the irradiation.

TABLE 2

| | Adhesive strength | | | | Moist | Shear | Curing |
|---|---|---|---|---|---|---|---|
| | | TAC | PET | Heat | heat | strain | rate |
| Section | Glass | film | film | resistance | resistance | (%) | (%) |
| Ex. 1 | 19.0 | 10.5 | 12.0 | ◯ | ◯ | 320 | 92 |
| Ex. 2 | 21.0 | 13.5 | 15.0 | ⊚ | ◯ | 250 | 94 |
| Ex. 3 | 28.0 | 15.1 | 18.0 | ⊚ | ◯ | 280 | 93 |
| Ex. 4 | 19.2 | 13.6 | 16.0 | ◯ | ⊚ | 210 | 91 |
| Ex. 5 | 20.0 | 12.4 | 14.0 | ◯ | ⊚ | 200 | 92 |
| Ex. 6 | 13.4 | 9.3 | 10.5 | ◯ | ◯ | 260 | 88 |
| Ex. 7 | 21.0 | 15.8 | 18.3 | ◯ | ⊚ | 230 | 96 |
| Ex. 8 | 28.1 | 12.5 | 14.3 | ◯ | ◯ | 180 | 95 |
| Ex. 9 | 15.1 | 12.3 | 11.5 | ◯ | ◯ | 240 | 89 |
| Com. | 25.0 | 3.2 | 5.4 | Δ | X | ∞ | 91 |
| Ex. 1 | | | | | | | |
| Com. | 3.2 | 0.8 | 1.2 | Δ | X | ∞ | 92 |
| Ex. 2 | | | | | | | |
| Com. | 1.2 | 12.0 | 15.4 | X | X | ∞ | 91 |
| Ex. 3 | | | | | | | |
| Com. | 1.3 | 8.7 | 11.8 | Δ | X | ∞ | 89 |
| Ex. 4 | | | | | | | |
| Com. | 10.4 | 6.5 | 9.1 | ◯ | Δ | ∞ | 94 |
| Ex. 5 | | | | | | | |
| Com. | 8.3 | 4.5 | 7.8 | Δ | Δ | ∞ | 95 |
| Ex. 6 | | | | | | | |
| Com. | 23.1 | 2.4 | 4.1 | Δ | X | ∞ | 87 |
| Ex. 7 | | | | | | | |
| Com. | 14.0 | 8.1 | 10.3 | Δ | X | ∞ | 89 |
| Ex. 8 | | | | | | | |

As shown in the above TABLE 2, it can be seen that each of the adhesive compositions described in Examples 1 to 9 according to the present invention, which includes a mono-functional urethane acrylate oligomer, isobornyl (meth)acrylate as a first mono-functional diluted monomer, a second mono-functional diluted monomer having a glass transition temperature (Tg) of not less than 1□ and an unsaturated ethylene group, and a free radical photo-initiator, may exhibit excellent adhesiveness (to a glass, TAC film and PET film), durability (e.g., heat resistance, moist heat resistance), and shear strain. Specifically, it was confirmed that the inventive adhesive composition can achieve excellent adhesiveness to both the glass, TAC film and PET film.

In contrast, although Comparative Examples 1 to 8 demonstrated high adhesiveness to a glass, TAC film or PET film, respectively, they did not have simultaneously superior adhesiveness to all of the foregoing. Furthermore, it was found that they have relatively low durability.

Moreover, all of Comparative Examples 1 to 8 encountered cohesive failures within 3600 sec, thereby demonstrating poor shear strain.

As is apparent from the above, the adhesive composition of the present invention may exhibit excellent adhesiveness to inorganic materials as well as plastic materials, and attain advantages such as superior durability, i.e., heat resistance and moist heat resistance, and shear strain.

In addition, the adhesive composition does not contain an alternative solvent, thus enabling production of a thick adhesive film.

Moreover, the inventive adhesive composition shows excellent shear strain, thus being effectively used to manufacture touch screens, touch panels, or the like.

While the present invention has been described with reference to the preferred embodiments, it will be understood by those skilled in the related art that various modifications and variations may be made therein without departing from the scope of the present invention as defined by the appended claims.

1. (Currently mended) An adhesive composition for optical use, comprising:
40 to 80 wt. % of a mono-functional urethane acrylate oligomer;
5 to 55 wt. % of isobornyl (meth)acrylate as a first mono-functional diluted monomer;
5 to 55 wt. % of a second mono-functional diluted monomer having a glass transition temperature (Tg) of not less than 1° C. and an unsaturated ethylene group; and
0.1 to 5 wt. % of a free radical photo-initiator.

2. The composition according to claim 1, wherein the mono-functional urethane acrylate oligomer has an ester main chain, an ether main chain, or a main chain having a combined structure of both the aforesaid main chains.

3. The composition according to claim 1, wherein the second mono-functional diluted monomer has a glass transition temperature (Tg) ranging from 1 to 150° C.

4. A pressure-sensitive adhesive for optical use, formed by curing the adhesive composition according to claim 1.

5. An adhesive film comprising:
a transparent substrate film; and
the adhesive according to claim 4 formed on one face of the transparent substrate film.

6. The adhesive film according to claim 5, wherein the adhesive has a thickness of 25 to 1000 μm.

7. A pressure-sensitive adhesive for optical use, formed by curing the adhesive composition according to claim 2.

8. A pressure-sensitive adhesive for optical use, formed by curing the adhesive composition according to claim 3.
